(19) United States
(12) Patent Application Publication
(10) Pub. No.: US 2007/0041395 A1
(43) Pub. Date: Feb. 22, 2007

(54) Data transmission method

(76) Inventors: Alfred Boucek, Schonkirchen (AT); Mohammad Reza Oskouel, Wien (AT)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/572,900

(22) PCT Filed: Aug. 4, 2004
(86) PCT No.: PCT/EP04/51718

§ 371 Date: Mar. 21, 2006

(30) Foreign Application Priority Data
Sep. 26, 2003 (DE) 10344764.4

(51) Int. Cl. H04J 3/16

(52) U.S. Cl. 370/437

(57) ABSTRACT

According to the invention, connection data (port-id) representing at least one subscriber's connection located in at least one communication network are transmitted to the at least one communication network. The transmitted connection data are used to authenticate the data transmitted via the at least one subscriber's connection. Preferably, additional connection data representing the subscriber's connection are available in addition to the subscriber-related data (user name and password) that are usually available for the authentication or authorization of the subscriber initiating a communication link via the communication network, thereby improving integrity of data transmission.

### CROSS REFERENCE TO RELATED APPLICATIONS

This application is the US National Stage of International Application No. PCT/EP2004/051718, filed Aug. 4, 2004 and claims the benefit thereof. The International Application claims the benefits of Germany Patent application No. 10344764.4 filed Sep. 26, 2003, all of the applications are incorporated by reference herein in their entirety.

### FIELD OF THE INVENTION

The invention relates in general to a data transmission method, and more specifically to a data transmission method that authenticates data to be transmitted in a communication network via a connecting line.

### BACKGROUND OF THE INVENTION

Within the framework of optimizing current communication networks, particularly broadband subscriber access networks—also called access networks—access to broadband services such as, for example, the “broadband Internet connection” or “Video on Demand” is to be made available to a large number of subscribers in a cost-effective manner.

In the subscriber access area of current communication networks, communication devices such as, for example, Network Termination (NT) devices are allocated to the subscribers or the subscriber via single wire or multiwire subscriber connecting lines connected to central switching devices or Digital Subscriber Line Access Multiplexers, DSLAM. An xDSL transmission method (for example, ADSL) is often used as the physical transmission method on the subscriber connecting line in which the data to be exchanged between the subscribers and the central switching device is transmitted, for example, within the framework of a packet-oriented or a cell-oriented transmission method (the Ethernet and/or the Asynchronous Transfer Mode, ATM). A communication link—also called a link—is established between, for example, a network termination device and the central switching the case of the ADSL protocol, the ADSL channels and therefore the transmission rate are set up accordingly.

A Local Area Network (LAN) is often located on the subscriber side, via which one or more communication terminals (such as, for example, a personal computer, a workstation, a server, multimedia terminals, etc.) allocated to a subscriber in each case, are connected to the network termination device allocated to the specific subscribers and, as a result, are connected via the subscriber connecting line to the switching device or to the DSLAM. The local communication networks or LANs located in the subscriber area are embodied for example, in accordance with the Ethernet transmission method or protocol—in accordance with the IEEE 802.3 standard or in accordance with II or the Ethernet V2—designed as a frame-oriented or a packet-oriented, connectionless communication network. The Ethernet data frames or the Ethernet frames formed in the subscriber area are inserted into ATM cells and transmitted to the switching device or to the DSLAM via the subscriber connecting line. The Ethernet data frames transmitted by means of the ATM transmission technology to the switching device or to the DSLAM are subsequently forwarded via at least one additional higher-ranking communication network connected to it, which can be designed in accordance with any packet-oriented or cell-oriented transmission method—for example, ATM, IEEE 802.x or the Internet protocol IP.

For the packet-oriented transmission of data (such as, for example, the Ethernet frames) via point-to-point connections—which can for example be designed as a modem connection, an ISDN connection, a frame relay connection, an X.25 connection or an SDH connection—the point-to-point protocol (PPP) is often used. The PPP consists of the following three components.
A method for the transmission of packet-oriented data packed accordingly—also called PPP encapsulation. This is based on a bidirectional full-duplex transmission,
Establishing, configuring and testing a transmission link by using the Link Control Protocol (LCP),
Establishing and clearing and configuring different layer-3 protocols by using the Network Control Protocol (NCP).

PPP can be transported via a plurality of protocols located in the lower layers in the OSI reference model such as, for example, the x.25 protocol, the frame relay protocol, the ISDN protocol, the ATM protocol as well as the Ethernet and the Internet protocol IP.

The transmission of PPP via communication networks embodied in accordance with IEEE 802.3 (the Ethernet) or in accordance with Ethernet V2 is also called PPPoE (PPP over Ethernet) and specified in accordance with RFC 2516.

The PPP-supported communication passes through a series of states:

However, before the start of the PPP-supported communication, a link between the subscriber (communication device or network termination device) and the switching device must for example be created by means of an xDSL protocol.

The system is for example “woken up” from the inactive state (link dead) by a carrier detect signal, which is usually generated by a modem. During the establishment of a communication link or a virtual connection (link establishment phase), the configuration of the link is set up by means of Link Control Protocol (LCP) messages. An authentication phase can follow the link establishment phase, if required.

By using the Network Control Protocol (NCP) and after an optional authentication has been implemented, a special configuration phase is performed for each network protocol. This is-followed by the transmission of useful data by means of the network layer protocol selected in each case.

The transmission of data can be ended at any time. This can occur because of external events such as, for example, loss of the layer-1 connection (loss of carrier) or deliberately by exchanging corresponding LCP messages.

As has already been explained, establishing a connection via a point-to-point protocol consists of two phases.
Configuring the link layer with the Link Control Protocol (LCP) and
Configuring the network layer with the Network Control Protocol (NCP).

Optional authentication can take place between these two configuration methods. The type of authentication used and when it is used is negotiated by using the LCP. Different methods for authentication are known, for example:
Password Authentication Protocol (PAP)
Challenge Handshake Authentication Protocol (CHAP)
PPP Extension Authentication Protocol (EAP)

For the authentication/authorization, a special network element provided for the purpose in the communication network—also called a Network Access Server (NAS) or an access router—must be informed about the subscriber who would like to be authenticated. Instead of this data being stored locally in the network access server, a server is often made available in the communication network to which a plurality of network access servers is allocated in each case. Because of these allocations, it is possible for a subscriber to login into the different locations of the communication network.

The authentication is undertaken in current communication networks by using a radius protocol (Remote Authentication Dial In User Service) by means of which a network access server exchanges data about the authentication, the authorization and the configuration with an authentication server (also called a radius server) especially provided for that purpose. The authentication server can also deal with other tasks, for example, within the framework of collecting a fee (charge registration).

The authentication methods currently used in communication networks are mainly based on verifying transmitted user data and passwords. However, this can no longer be sufficient for the integrity requirements, which are becoming increasingly important with regard to the transmission of data via communication networks.

### SUMMARY OF THE INVENTION

The object of the invention is to improve the integrity of the transmission of data within communication networks. This object of the invention is achieved starting from a method and a communication system in accordance with the features of claims.

The essential aspect of the method in accordance with the invention for the transmission of data via at least one connection of the subscriber located in at least one communication network consists of the fact that the connection data representing the at least one subscriber's connection is transmitted to the communication network. The transmitted connection data is used to authenticate the data to be transmitted via the at least one connection of the subscriber.

The main advantage of the method in accordance with the invention is the fact that preferably, additional connection data representing the subscriber's connection is made available for verification purposes in addition to the subscriber-related data (user name and password) that is usually available for the authentication or authorization of the subscriber initiating a communication link via the communication network. Network elements located in current communication networks, in particular, the Network Access Server (NAS) or the access router usually have no data about the port or subscriber's connection or the subscriber connecting line through which the subscriber is actually connected to the communication network. As a result, the transmission of connection data represents an additional integrity function, thereby improving the authentication of subscribers and in this way improving the integrity of data transmitted via the communication network.

Advantageously, the data is transmitted in accordance with the PPPoE transmission method or protocol in accordance with RFC 2516 via the at least one subscriber's connection. Within the framework of the PPPoE protocol, specification RFC 2516 allows so-called “TAGS” so that advantageously the connection data is inserted as the “Relay Session ID Tag” data into the “PPPoE Active Discovery” (PADI) messages transmitted to the communication network via the at least one subscriber's connection. This advantageous development does not represent a further development, but an advantageous application of the PPPoE transmission protocol, in which already existing transmission resources or data fields are used in the PADI messages for the transmission of the connection data—the PPPoE protocol does not have to be modified or supplemented.

Further advantageous developments of the method in accordance with the invention as well as a communication system in order to improve the integrity of the transmission of data can be found in the additional claims.

### BRIEF DESCRIPTION OF THE DRAWINGS

The method in accordance with the invention is explained in detail on the basis of the following drawings. They are as follows

FIG. 1 a communication system in which the method in accordance with the invention is employed and

FIG. 2 inserting the connection data into the PPPoE transmission protocol according to the invention

### DETAILED DESCRIPTION OF THE INVENTION

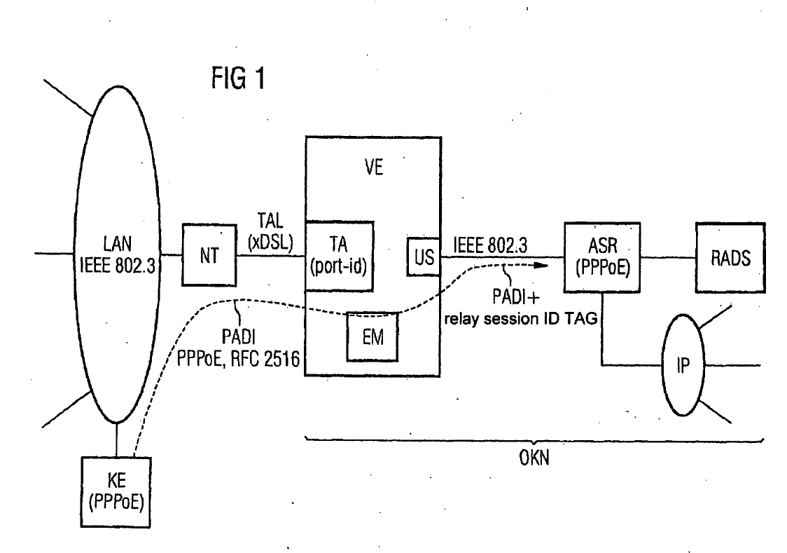

FIG. 1 shows in a block diagram, a switching device VE located in a higher-ranking communication network OKN, and said switching device VE can be designed as a digital access multiplexer device—also called a DSLAM, Digital Subscriber Line Access Multiplexer. The switching device VE has a plurality of subscribers' connections TA—in FIG. 1 only one subscriber's connection is shown representing a number of connections—to which a network termination device NT (Network Termination) is connected via a subscriber connecting line TAL and on the subscriber side. The subscriber's connection TA shown in the block diagram forms part of a line unit, which has a plurality of these connections—not shown. A local communication network LAN designed in accordance with the Ethernet transmission method (IEEE Standard IEEE 802.3 or the Ethernet V2) and allocated to a subscriber is connected to the network termination device NT. Via the local communication network LAN, a plurality of communication terminals such as for example a personal computer and multimedia communication terminals are connected via the subscriber connecting line and via the switching device VE to the higher-ranking communication network OKN. A modem is in each case located in both the network termination device NT and in the subscriber line unit TAE—not shown—through which, in this embodiment, an xDSL transmission method such as for example ADSL is used as the physical transmission method via the subscriber connecting line TAL.

The switching device VE is connected, via an uplink interface US and an uplink connection LNK, to a network access device ASR—also called an access router in the following—located in the higher-ranking communication network OKN. An authentication server RADS located in the higher-ranking communication network OKN is also allocated to the Access Router ASR and in which different functions for the authentication and authorization of subscribers initiating communication links are likewise performed in said authentication server RADS. The authentication or authorization takes place, for example, in accordance with the radius protocol. Access of subscribers is controlled for example via the Access Router ASR located locally in an Internet Service Provider (ISP) in the Internet IP forming a component of the higher-ranking communication network OKN.

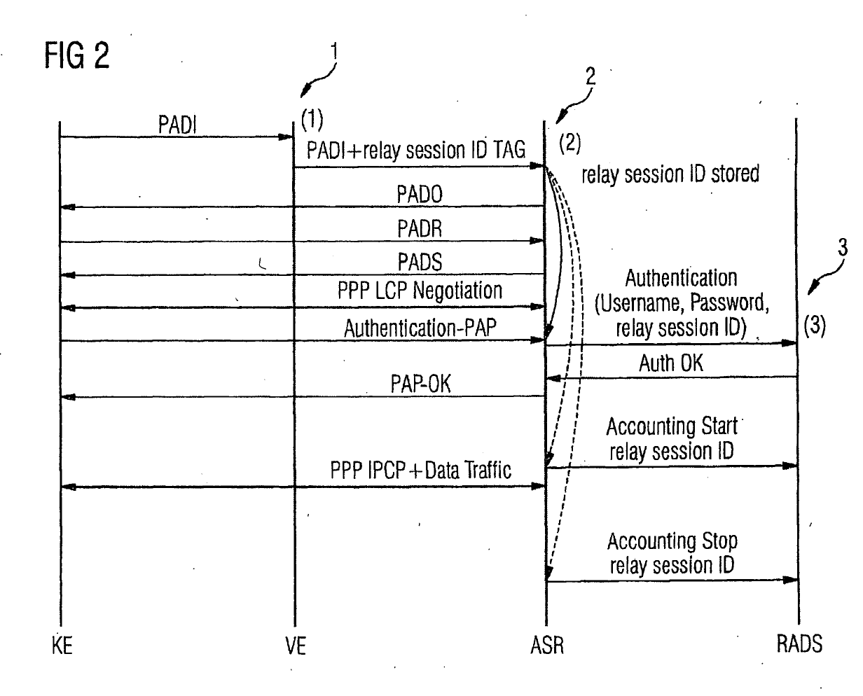

The method in accordance with the invention is explained in greater detail below. For the subsequent embodiments, reference is at the same time made to FIG. 2, in which the exchange of messages is shown within the framework of the PPPoE protocol when a communication link or connection is established between the participating communication devices.

It is assumed that a data connection is to be established into the Internet IP via the communication terminal KE—for example, a personal computer located in an Internet Café—connected to the LAN on the subscriber side. For this purpose, the communication terminal KE initiates the establishment of a PPPoE connection to the Access Router ASR located in the higher-ranking communication network OKN. In this case, the communication terminal KE is a PPPoE client and the Access Router ASR a PPPoE server. The PPPoE client can also be located in the network termination device NT. Via the insertion means EM located in the switching device VE, the PADI packets transmitted by the communication terminal KE are identified within the framework of the PPPoE protocol in the direction of the Access Router ASR and expanded by default by means of the “Relay Session ID TAG”—see point 1 in FIG. 2. According to the invention, said inserted relay session ID TAG represents a connection data port-id—here the port-ID—representing the subscriber's connection TA or the subscriber connecting line TAL. Via the PORT-ID, the subscriber's connection TA or the subscriber connecting line TAL connected to it is identified unambiguously within the switching device or in the corresponding line unit and addressed as a result. The PADI packets expanded by the insertion means EM are transmitted from the switching device VE via the uplink connection LNK to the PPPoE server located in the Access Router ASR, via which server the PPPoE protocol is terminated—indicated in FIG. 1 by means of the broken line with the arrowhead. Via the PPPoE server, the specific TAG value of the relay session ID representing the PORT-ID or the connection data contained in the PADI messages is extracted. The extracted connection data port-id can optionally be stored in the Access Router ASR together with the customary subscriber-associated authentication data (such as for example the user name or user identification and the password)—see point 2 in FIG. 2. The connection data port-id extracted in this way is forwarded from the access router, in the course of the authentication to be implemented, to the Radius Server RADS—see point 3 in FIG. 2.

The connection data port-id, together with the additional subscriber-associated authentication data, is transmitted to the Radius Server RADS, for example, within the framework of authentication requests and accounting requests, typically with the radius attribute 31 “Calling Station ID” specified in the standard RFC 2516.

Via the Radius Server RADS, the transmitted connection data port-ID can for example within the framework of the authentication be compared with the username and password transmitted in parallel, thereby increasingly improving the integrity of the transmission of data.

After a successful authentication of the subscriber, the Access Router ASR establishes a useful data connection between the subscriber and the communication network—here, the Internet IP—via which the data is transmitted or exchanged.

The connection data port-id can be transmitted to the communication network both during the establishment of a communication link such as for example a PPP connection and during the entire existence of the communication link.

The connection data port-id can also be transmitted within the framework of another transmission protocol, such as for example:
PPTP Point-to-Point Tunneling Protocol
L2PT Layer-2 Tunneling Protocol

1-11. (canceled)

12. A method for performing data transmission via a subscriber's connection located in a communication network which is in accordance with Ethernet transmission method, comprising:
having a connection data that represents the subscriber's connection;
transmitting the connection data and data to be transmitted via the subscriber's connection in accordance with PPPoE transmission method and in accordance with RFC 2516;
inserting the connection data as “Relay Session ID TAG” into PPPoE Active Discovery messages;
transmitting the PPPoE Active Discovery messages to the communication network via the subscriber's connection; and
authenticating the data to be transmitted by using the connection data which is contained in the PPPoE Active Discovery messages.

13. The method as claimed in claim 12, wherein the connection data is a port identification or PORT-ID and represents a subscriber connecting line that is connected to the subscriber's connection.

14. The method as claimed in claim 12, wherein the connection data is stored in the communication network.

15. The method as claimed in claim 12, wherein the data to be transmitted is transmitted within a framework of a communication link via the subscriber's connection and the connection data is transmitted to the communication network on an establishment of the communication link.

16. The method as claimed in claim 12,
wherein the subscriber's connection is allocated to a switching device located in the communication network,
wherein the connection data is inserted as “Relay Session ID TAG” into the PPPoE Active Discovery messages through the switching device,
wherein the PPPoE Active Discovery messages which contains the connection data is transmitted to an access network element located in the communication network,
wherein the specific TAG value of the Relay Session ID TAG which represents the connection data contained in the messages is extracted in the access network element,
wherein the extracted connection data is transmitted from the access network element to an authentication network element located in the communication network, and
wherein the data to be transmitted is verified by the authentication network element by using the connection data.

17. The method as claimed in claim 12, wherein the subscriber is connected to the communication network via the subscriber's connection and authentication is verified by using the connection data and by using subscriber data which represents the subscriber.

18. The method as claimed in claim 17, wherein the subscriber data includes a user name and a password.

19. A communication system for performing data transmission via a subscriber's connection located in a communication network which is in accordance with Ethernet transmission method, comprising:
a connection data that represents a subscriber's connecting line that is connected to the subscriber's connection;
a transmitter that transmits the connection data to the communication network; and
an authenticator located in the communication network that verifies authenticity of data to be transmitted via the subscriber's connecting line by using the connection data.

20. The communication system as claimed in claim 19, wherein the subscriber's connecting line is a wire connecting line through which the subscriber is physically connected to the communication network.

21. The communication system as claimed in claim 19, wherein the connection data and the data to be transmitted in the communication network via the subscriber's connection is transmitted in accordance with PPPoE transmission method and in accordance with RFC 2516.

22. The communication system as claimed in claim 19, wherein the connection data is inserted as the “Relay Session ID TAG” into PPPoE Active Discovery messages via the transmitter and is transmitted via the subscriber's connection to the communication network.

23. The communication system as claimed in claim 19, wherein the connection data is a port identification or PORT-ID.

24. The communication system as claimed in claim 19, wherein the subscriber's connection and the transmitter are allocated to a switching device located in the communication network.

25. A communication device for a communication system for performing data transmission via a subscriber's connection located in a communication network which is in accordance with Ethernet transmission method, comprising:
a connection data that represents a subscriber's connecting line that is connected to the subscriber's connection;
a transmitter that is allocated to the communication device and transmits the connection data to the communication network; and
an authenticator located in the communication network that verifies authenticity of data to be transmitted via the subscriber's connecting line by using the connection data,
wherein the connection data and the data to be transmitted in the communication network via the subscriber's connection is transmitted in accordance with PPPoE transmission method and in accordance with RFC 2516,
wherein the connection data is inserted as the “Relay Session ID TAG” into PPPoE Active Discovery messages via the transmitter and is transmitted via the subscriber's connection to the communication network.

26. The communication device as claimed in claim 25, wherein the subscriber's connecting line is a wire connecting line through which the subscriber is physically connected to the communication network.
